(19) United States
(12) Patent Application Publication
(10) Pub. No.: US 2016/0297384 A1
(43) Pub. Date: Oct. 13, 2016

(54) Vehicle-borne Solar Cold Storage System

(71) Applicant: SHANGHAI YING TA AIRCONDITION ENTERPRISE CO., LTD, Shanghai (CN)

(72) Inventor: Jincai GUO, Shanghai (CN)

(21) Appl. No.: 14/771,807

(22) PCT Filed: Nov. 26, 2014
(86) PCT No.: PCT/CN2014/092314

§ 371 Date: Sep. 1, 2015

(30) Foreign Application Priority Data
Nov. 14, 2014 (CN) 201410647929.3

(51) Int. Cl. B60R 16/033; H02J 7/35; H02J 7/00; F25B 27/00

(52) U.S. Cl. CPC B60R 16/033; F25B 27/002; H02J 7/35; H02J 7/0068

(57) ABSTRACT

A vehicle-borne solar cold storage system includes: a power supply management controller, a battery pack and a power-consuming equipment for refrigeration; wherein the power supply management controller includes: a solar power supply management module used to manage the solar cell set to charge and discharge the battery pack, a motor vehicle generation power supply management module used to manage the vehicle motor power supply to charge and discharge the battery pack; a DC module for raising voltage; a master control module used to set the working mode and control the solar power supply management module; and a motor vehicle generation power supply management module to work under the working mode set. The present invention integrates solar energy resources, manages comprehensively the solar cell power supply and the motor vehicle through the power supply management controller and allocates rationally to the cold storage system.

### CROSS REFERENCE OF RELATED APPLICATION

This is a U.S. National Stage under 35 U.S.C 371 of the International Application PCT/CN2014/092314, filed Nov. 26, 2014, which claims priority under 35 U.S.C. 119(a-d) to CN 201410647929.3, filed Nov. 14, 2014.

### BACKGROUND OF THE PRESENT INVENTION

1. Field of Invention

The present invention relates to a temperature control technology and more specially to a vehicle-borne solar cold storage system.

2. Description of Related Arts

Vehicle-borne cold storage system has been applied widely in a lot of fields in recent years, especially in such industries as food, pharmaceutical for transportation. The traditional vehicle-borne cold storage system relies on consuming motor vehicle fuel to provide electricity and power to the cold storage system. The basic principle is as shown in FIG. 1:

When motor vehicle engine operates, the power transmission device (belt, gear, etc.) drives the generator and compressor to work. After the generator works, the power energy produced is conveyed to the power-consuming equipment via the motor vehicle battery pack; after the compressor works, the coolant flowing past the internal pipeline is subject to a sufficient compression treatment and is available for use by the cold storage system through releasing to the pipeline of the cold storage system.

That mode supplies power to the cold storage system by consuming a large amount of fuel. On one hand, a large amount of environmentally harmful gases will be produced during fuel combustion resulting in aggravated environmental pollution; on the other hand, fuel itself being non-renewable resources can only become less and less. Moreover, when the engine stops operation (for example, temporary shutdown), the compressor will also stop and the cold storage system cannot work. If it is wanted that the goods in the cold storage is not affected, it is imperative to ensure that the engine is free from stalling in a shutdown condition, or it means that the goods in the cold storage must be moved to a safe low-temperature environment. This brings a great inconvenience to long-distance transportation and simultaneously increases a lot of additional costs.

### SUMMARY OF THE PRESENT INVENTION

In consideration of the defects existing in the current technology, the purpose of the present invention is to provide a vehicle-borne solar cold storage system.

The present invention provides a vehicle-borne solar cold storage system, including: a solar cell set, a motor vehicle power supply, a power supply management controller, a battery pack and a power-consuming equipment for refrigeration;
wherein, the power supply management controller includes:
a solar power supply management module used to manage the solar cell set to charge and discharge the battery pack,
a motor vehicle generation power supply management module used to manage the vehicle motor power supply to charge and discharge the battery pack,
a DC module for raising a voltage (which is a DC TO DC module for raising the voltage) used to raise and stabilize the voltage managed by the solar power supply management module and the motor vehicle generation power supply management module; and
a master control module used to set a working mode, and control solar power supply management module and the motor vehicle generation power supply management module to work under the working mode set.

Preferably, there is a working mode A: when the power-consuming equipment for refrigeration works during motor vehicle traveling, the master control module detects the solar cell set and the motor vehicle power supply;
when a power of the solar cell set is sufficient for the power-consuming equipment for refrigeration, the motor vehicle power supply is cut off through the motor vehicle generation power supply management module, the power-consuming equipment for refrigeration is driven through the solar power supply management module utilizing solar energy and if there is excessive power, the battery pack is charged through the solar power supply management module;
when the power of the solar cell set is not sufficient, the master control module cuts off the supply of power of the solar cell set to the power-consuming equipment for refrigeration through the solar power supply management module, and turns to use the motor vehicle power supply managed by the motor vehicle generation power supply to supply power to the power-consuming equipment for refrigeration; and still charges the battery pack through the solar cell set until an output voltage of the solar cell set is lower than a lowest charging voltage of the battery pack.

Preferably, there is a working mode B: when the power-consuming equipment for refrigeration works during motor vehicle parking, the master control module cuts off the motor vehicle power supply through the motor vehicle generation power supply management module;
when the power of the solar cell set is sufficient for the power-consuming equipment for refrigeration, the solar cell set is controlled to supply power to the power-consuming equipment for refrigeration through the solar power supply management module, if there is excessive power, the battery pack is charged through the solar power supply management module;
when the power of the solar cell set is not sufficient, the master control module the battery pack to discharge to provide power energy to the power-consuming equipment for refrigeration; and controls the solar cell set to charge the battery pack until output voltage of the solar cell set is lower than the lowest charging voltage of the battery pack.

In comparison with the current technology, the present invention has the following beneficial effects:
1. The present invention integrates solar energy resources on basis of traditional vehicle-borne cold storage system. As a result, emission of harmful gases and energy loss are reduced effectively;
2. The present invention manages comprehensively the solar cell power supply and the motor vehicle through the power supply management controller, allocates rationally to the cold storage system, to ensure the system to work in such a mode as the most energy-saving and convenient all the time. At the same time, a DC module for raising power supply voltage is added in, so that the application of the system covers vehicle-borne cold storages of different specifications. Especially, it can be ensured that the cold storage system can work normally in a parking state without having to start the motor vehicle; and
3. By integrating into one unit in the present invention, the structure arrangement is rational and the operation and use is convenient.

### BRIEF DESCRIPTION OF THE DRAWINGS

By reading and referring to the detailed description of the following figures to the non-restrictive embodiment, other characteristics, purposes and advantages of the present invention will become more conspicuous:

FIG. 1 is a technical scheme of a conventional technology.

FIG. 2 is a structural schematic diagram of the present invention.

FIG. 3 is a van where solar panels are laid (a top and a side).

FIG. 4 is an integrated unit of a cold storage system.

FIG. 5 is a solar vehicle-borne cold storage vehicle.

FIG. 6 is a structure schematic diagram of a power supply management controller.

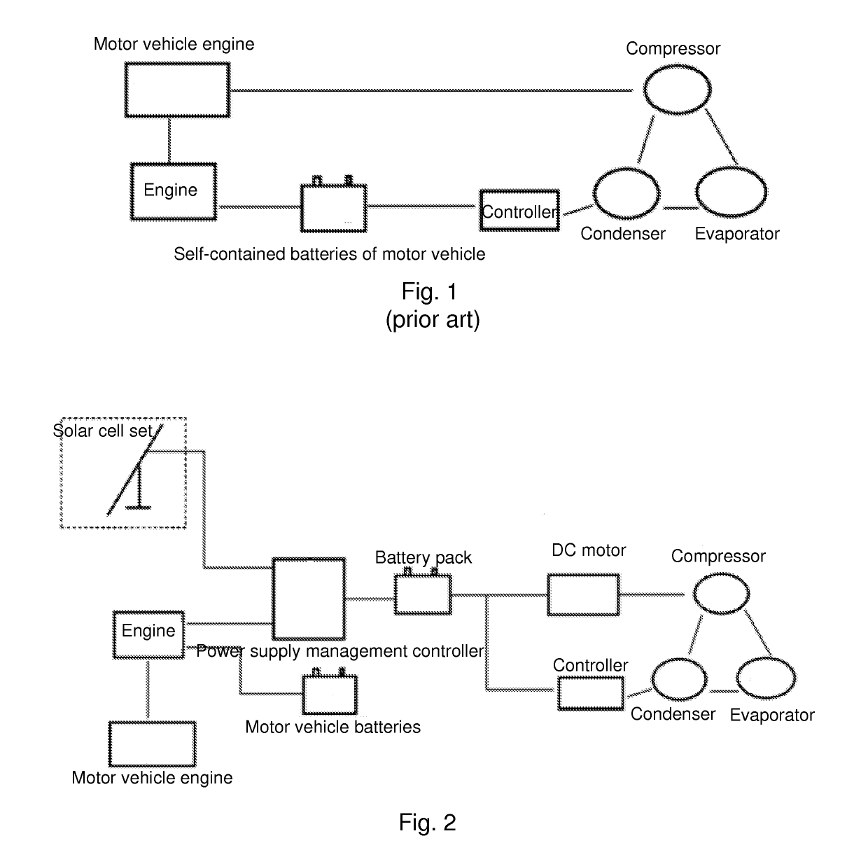

### DETAILED DESCRIPTION OF THE PREFERRED EMBODIMENT

In the following, an embodiment will be combined to give a detailed description to the present invention. The following embodiment will help the technical people in this field to further understand the present invention. However, it does not restrict the present invention in any form. It should be pointed out that for ordinary technical people in this field, a number of variations and improvements can be made under the prerequisite of not being divorced from the conception of the present invention. All these belong to the protection scope of the present invention.

Solar energy resources is inexhaustible and cannot be used up, which is one of the natural resources having the most capability to solve energy crisis in addition to water resources. Especially in summer, the solar energy resources are rich in particular and the use rate of vehicle-borne cold storage is highest. On basis of this, the present invention provides a kind of new solar vehicle-borne cold storage system, which integrates solar energy resources on basis of traditional vehicle-borne cold storage system and as a result, reduces effectively the emission of harmful gases and energy loss. At the same time, that system can still ensure the cold storage system to work normally in a parking state without having to start the motor vehicle.

The schematic diagram of the new solar vehicle-borne cold storage system is shown in FIG. 2. A compressor of the cold storage system is driven by a DC brushless motor. A power supply manager manages in a unified manner a two-way supply of power of the system. When the power supply manager detects that an electricity quantity at a solar end is sufficient, the power supply manager cuts off the supply of power to the motor vehicle generator end automatically; when detecting that the solar power is not sufficient, the power supply manager switches to the motor vehicle system for supplying power. If it is necessary to provide power energy utilizing solar energy in a parking state, a setup is able to be made at the power supply management control end to ensure that the solar end reserves sufficient power energy in a parking state.

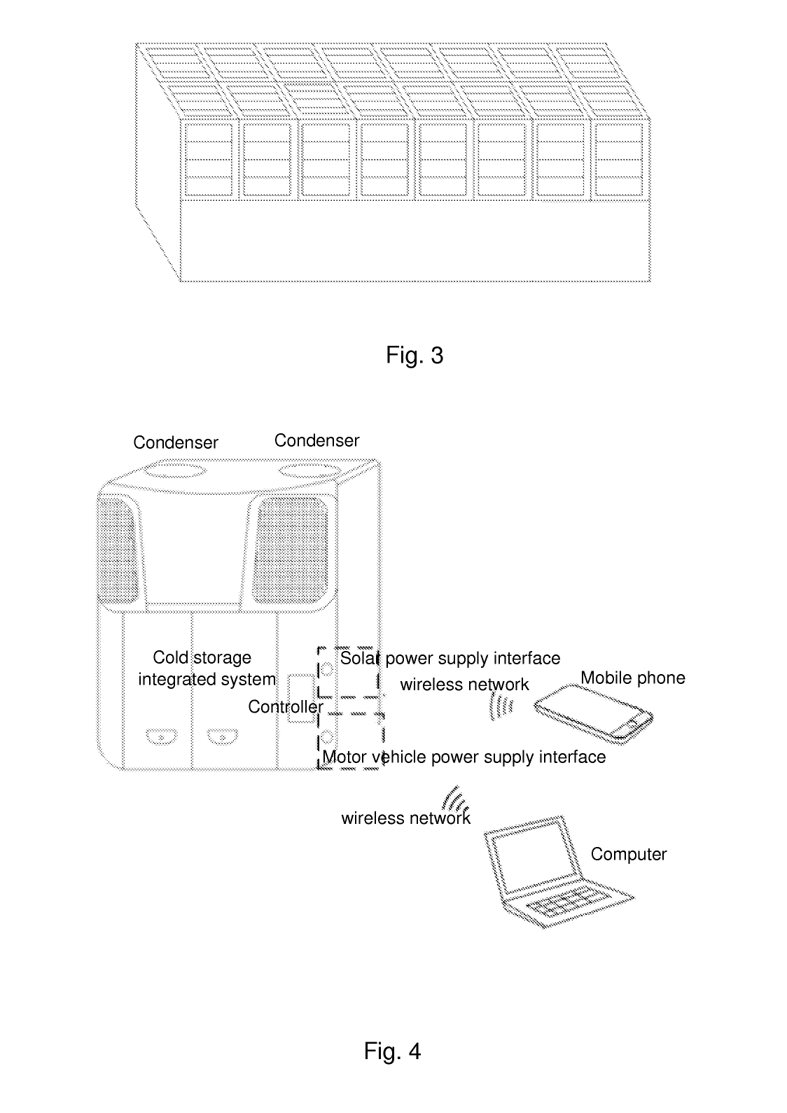

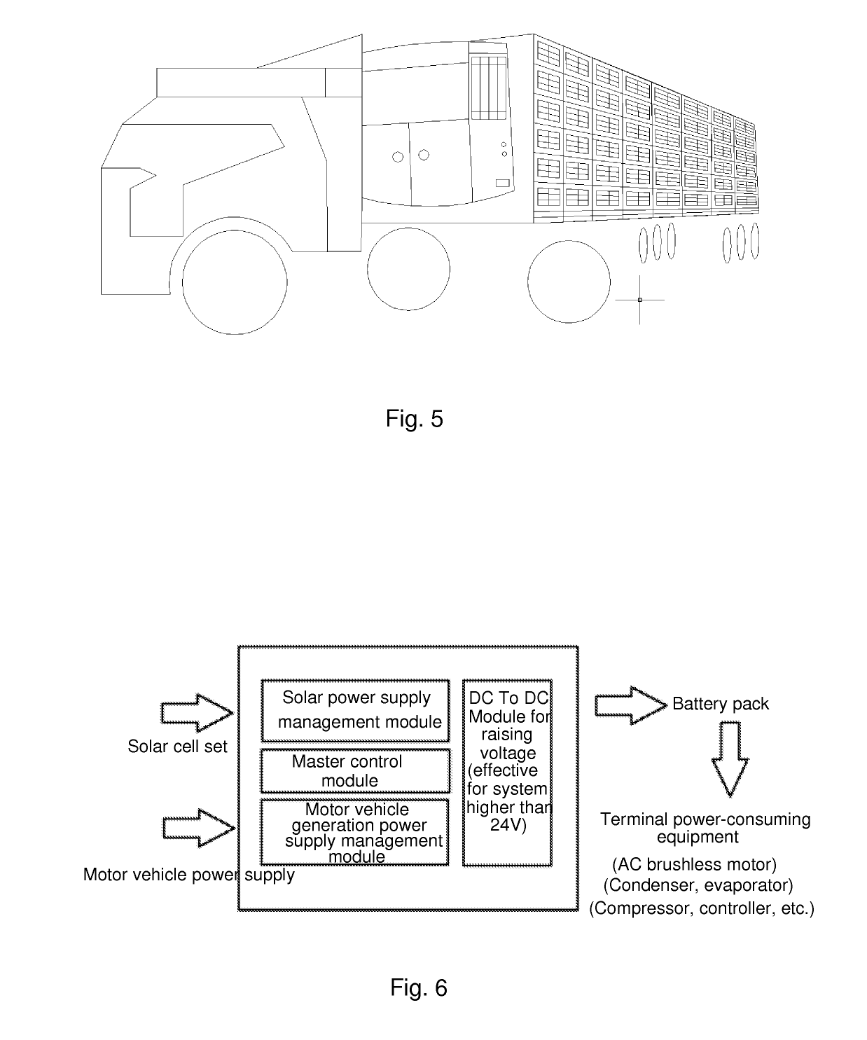

Specifically, solar cell sets are laid on top and two sides of the vehicle-borne cold storage van (as shown in FIG. 3), which is connected to a power supply management controller after being paralleled. The power supply management controller is responsible for solar energy battery charging management (preventing battery float charging, overcharging, etc.). At the same time, electricity from a motor vehicle generation system is also connected to the power supply management controller and conveyed to the DC motor (responsible to drive the compressor) and an evaporator, a condenser and a controller of the cold storage system after being subject to the unified management by the power supply manager;
wherein, the battery pack, the power supply management controller, the DC motor, the compressor, the evaporator, the condenser and controller are all integrated in an external unit of the vehicle-borne cold storage system, as shown in FIG. 4. The controller is located on the surface of the external unit to display an actual temperature in the cold storage and working conditions of all system parts. A user may set up parameters and perform manual operation through the controller. At the same time, a radio network (3G, 4G, or wifi) and a GPRS system are embedded in the controller. A customer is able to monitor remotely the cold storage temperature and vehicle positioning through a mobile equipment or a computer.

Further, the power supply management controller is responsible for the power supply management of the whole system, and a core thereof comprises a master control module of the solar power supply management module and a (DC TO DC) DC module for raising a voltage (which is effective in a system above 24V). The block diagram is shown in FIG. 6, wherein the power-consuming equipment for refrigeration comprises the DC brushless motor, the condenser, the evaporator, and the compressor.

The solar power supply management module is responsible for management of solar battery charging and discharging and has such protections as against overcharging, over-discharging, overload, over-temperature, over-current, etc. The motor vehicle power supply management module is responsible to manage the motor vehicle power supply to charge and discharge the batteries and similarly has such protections as against over-charging, over-discharging and overload. The DC (DC TO DC) module for raising the voltage is responsible to raise and stabilize the voltage after being managed according to the system requirement. The master control module is responsible to allocate the system working mode to ensure the system to work in the most effective mode.

When the cold storage system (24V) works during motor vehicle traveling, the main control module detects the two ways of power supplies (solar cell set and motor vehicle power supply). When a power of the solar cell set is sufficient for the terminal power-consuming equipment, motor vehicle power supply is disconnected and the vehicle-borne cold storage system is driven through the solar power supply management module utilizing solar energy and if there is excessive power, the battery pack is charged through the solar power supply management module; when the solar energy power is not sufficient, the master control module cuts off the solar cell set supplying to the system and turns to use the motor vehicle power supply to supply power to the system after being subject to motor vehicle generation power supply management. At this point, the solar cell set still charges the batteries until the solar energy is lower than a lowest charging voltage. In case of being a system higher than 24V, the power supply, after being subject to management by the solar power supply management module and the motor vehicle generation power supply management module, has to be converted by the DC (DC TO DC) module for raising voltage first before supplying power to the system or charging the batteries.

When the cold storage system (24V) works during motor vehicle parking (the motor vehicle stalls and the engine does not work), the master control module switches directly to the system power supply to supply power for the solar cell set. When the power of the solar cell set is sufficient for the terminal power-consuming equipment, the vehicle-borne cold storage system is driven by the solar power supply management module utilizing solar energy and if there is excessive power, the battery pack is charged through the solar power supply management module; when the solar energy power is not sufficient, the battery pack discharges directly for the system to work. At this point, the solar cell set still charges the batteries until the solar energy is lower than the lowest charging voltage. In case of being a system higher than 24V, the power supply managed by the solar power supply management module has to be converted by the DC (DC TO DC) module for raising the voltage firstly before supplying power to the system or charging the batteries.

The power supply management controller manages comprehensively the solar cell power supply and motor vehicle power supply and allocates rationally to the cold storage system to ensure the system to work in such a mode as the most energy-saving and convenient all the time. At the same time, a DC module for raising a power supply voltage is added in, so that the application of the system covers vehicle-borne cold storages of different specifications.

An embodiment of the present invention is described above. It is necessary to understand that the present invention is not restricted to the above specific embodiment. The technical people in this field can make different variations or modifications within the range of claim and this does not influence the essential contents of the present invention.

What is claimed is:

1. A vehicle-borne solar cold storage system, including: a solar cell set, a motor vehicle power supply, a power supply management controller, a battery pack, and a power-consuming equipment for refrigeration;
wherein, the power supply management controller includes:
a solar power supply management module used to manage the solar cell set to charge and discharge the battery pack;
a motor vehicle generation power supply management module used to manage the motor vehicle power supply to charge and discharge the battery pack;
a DC module for raising a voltage used to raise and stabilize the voltage after being managed by the solar power supply management module and the motor vehicle generation power supply management module; and
a master control module used to set a working mode, and control the solar power supply management module, and the motor vehicle generation power supply management module to work under the working mode set.

2. The vehicle-borne solar cold storage system according to claim 1, wherein in a working mode A: when the power-consuming equipment for refrigeration works during motor vehicle traveling, the master control module detects the solar cell set and the motor vehicle power supply:
when a power of solar cell set is sufficient for the power-consuming equipment for refrigeration, the motor vehicle power supply is cut off through the motor vehicle generation power supply management module, the power-consuming equipment for refrigeration is driven through the solar power supply management module utilizing solar energy, and if there is excessive power, the battery pack is charged through the solar power supply management module;
when the power of the solar cell set is not sufficient, the master control module cuts off the supply of power of the solar cell set to the power-consuming equipment for refrigeration through the solar power supply management module, and turns to use the motor vehicle generation power supply managed by the motor vehicle power supply to supply power to the power-consuming equipment for refrigeration; and still charges the battery pack through the solar cell set until an output voltage of the solar cell set is lower than a lowest charging voltage of the battery pack.

3. The vehicle-borne solar cold storage system according to claim 1, wherein in a working mode B: when the power-consuming equipment for refrigeration works during motor vehicle parking, the master control module cuts off the motor vehicle power supply through the motor vehicle generation power supply management module;
when the power of the solar cell set is sufficient for the power-consuming equipment for refrigeration, the solar cell set is controlled to supply power to the power-consuming equipment for refrigeration through the solar power supply management module and if there is excessive power, the battery pack is charged through the solar power supply management module;
when the power of the solar cell set is not sufficient, the master control module controls the battery pack to discharge to provide power energy to the power-consuming equipment for refrigeration; and controls the solar cell set to charge the battery pack until an output voltage of the solar cell set is lower than a lowest charging voltage of the battery pack.
